(19) United States
(12) Patent Application Publication
(10) Pub. No.: US 2025/0118938 A1
(43) Pub. Date: Apr. 10, 2025

(54) CONNECTOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Masami SAKAI, Osaka (JP); Liping KANG, Mie (JP)

(21) Appl. No.: 18/836,010

(22) PCT Filed: Dec. 22, 2022
(86) PCT No.: PCT/JP2022/047353

§ 371 Date: Aug. 6, 2024

(30) Foreign Application Priority Data
Feb. 7, 2022 (JP) 2022-016975

(51) Int. Cl. H01R 24/40; H01R 103/00

(52) U.S. Cl. CPC H01R 24/40; H01R 2103/00

(57) ABSTRACT

A connector (10) includes a first outer conductor (15A), a second outer conductor (15B) and an overlapping portion (20). The first outer conductor (15A) has a hollow cylindrical shape and is crimped to a front end part of a shielded wire (W). The second outer conductor (15B) has a hollow cylindrical shape, is coaxially and externally fit to a front end part of the first outer conductor (15A) and extends forward of the first outer conductor (15A). The overlapping portion (20) is constituted by the front end part of the first outer conductor (15A) and a rear end part of the second outer conductor (15B) overlapped on the front end part of the first outer conductor (15A). The overlapping portion (20) includes an auxiliary portion (20A) for assisting assembly of the connector (10).

### TECHNICAL FIELD

The present disclosure relates to a connector.

### BACKGROUND

Patent Document 1 discloses a coaxial connector. This is coupled by inserting a contact portion provided in one contact part to be mounted on an axial cable into the other contact part including a plug head to be inserted into a socket or a coupling. A method for crimping or spot-welding the contact portion is known as a coupling method.

### PRIOR ART DOCUMENT

### Patent Document

Patent Document 1: U.S. Pat. No. 10,348,044 B2
Patent Document 2: JP 2021-051872 A

### SUMMARY OF THE INVENTION

### Problems to be Solved

The contact portion in Patent Document 1 has a smooth hollow cylindrical outer shape. Thus, relative positions of the one and the other contact parts may be shifted until the contact portion is crimped or spot-welded after the contact portion is inserted into the other contact part.

A connector of the present disclosure was completed on the basis of the above situation and aims to provide an easily assemblable connector.

### Means to Solve the Problem

The present disclosure is directed to a connector with a first outer conductor having a hollow cylindrical shape, the first outer conductor being crimped to a front end part of a cable, a second outer conductor having a hollow cylindrical shape, the second outer conductor being coaxially and externally fit to a front end part of the first outer conductor and extending forward of the first outer conductor, and an overlapping portion constituted by the front end part of the first outer conductor and a rear end part of the second outer conductor overlapped on the front end part of the first outer conductor, the overlapping portion including an auxiliary portion for assisting assembly of the connector.

### Effect of the Invention

According to the present disclosure, a connector can be easily assembled.

### BRIEF DESCRIPTION OF THE DRAWINGS

FIG. 1 is a side view in section of a connector of the present disclosure.

FIG. 2 is a back view of the connector of the present disclosure.

FIG. 3 is a section along A-A in FIG. 2.

FIG. 4 is a perspective view showing a first outer conductor crimped to a shielded wire.

FIG. 5 is a perspective view of a second outer conductor.

FIG. 6 is a side view showing a state where the second outer conductor having a dielectric inserted therein is externally fit to the first outer conductor.

FIG. 7 is a section along B-B in FIG. 2.

FIG. 8 is a section along C-C in FIG. 2.

### DETAILED DESCRIPTION TO EXECUTE THE INVENTION

### Description of Embodiments of Present Disclosure

First, embodiments of the present disclosure are listed and described.
(1) The connector of the present disclosure is provided with a first outer conductor, a second outer conductor and an overlapping portion. The first outer conductor has a hollow cylindrical shape and is crimped to a front end part of a cable. The second outer conductor has a hollow cylindrical shape, is coaxially and externally fit to a front end part of the first outer conductor and extends forward of the first outer conductor. The overlapping portion is constituted by the front end part of the first outer conductor and a rear end part of the second outer conductor overlapped on the front end part of the first outer conductor. The overlapping portion includes an auxiliary portion for assisting assembly of the connector. According to this configuration, the first and second outer conductors can be easily assembled by providing the overlapping portion with the auxiliary portion.
(2) Preferably, the auxiliary portion includes a first projecting portion provided in the first outer conductor and projecting radially outward, and a locking portion provided in the second outer conductor, the first projecting portion being locked to the locking portion. According to this configuration, the first projecting portion is locked to the locking portion, whereby relative positions of the first and second outer conductors are easily stabilized and the first and second outer conductors can be easily assembled.
(3) Preferably, a slit extending forward from a rear end of the second outer conductor is formed on each of both sides in a circumferential direction of the locking portion. According to this configuration, the locking portion can be resiliently formed outward and made easily lockable to the first projecting portion when the second outer conductor is externally fit to the end part of the first outer conductor.
(4) Preferably, a housing, into which the second outer conductor is inserted is further provided, and the second outer conductor is inserted into the housing from behind the housing. The auxiliary portion includes a second projecting portion provided in the second outer conductor, projecting radially outward and configured to restrict insertion of the second outer conductor beyond a proper insertion position into the housing. According to this configuration, since the second outer conductor can be provided with the second projecting portion while a shielding function in the overlapping portion is ensured by the first outer conductor, the shape of the second projecting portion can be determined without considering the shielding function. Thus, the second projecting portion is more flexibly shaped.
(5) Preferably, in (4), the auxiliary portion includes a third projecting portion provided in the second outer conductor and projecting radially outward, and the third projecting portion and the second projecting portion are arranged side by side in a circumferential direction of the second outer conductor. The housing includes accommodating portions formed by being recessed to correspond to the third projecting portion and the second projecting portion, the third projecting portion and the second projecting portion being respectively accommodated into the accommodating portions. According to this configuration, it is possible to prevent the insertion of a component provided with a projecting portion other than the second and third projecting portions (i.e. a component provided with a projecting portion not corresponding to the accommodating portions) into the housing.
(6) Preferably, in (5) indirectly dependent on (3), the second projecting portion and the third projecting portion are formed by cutting and raising the second outer conductor radially outward, and at least one of the second projecting portion and the third projecting portion is facing the slit. According to this configuration, since the auxiliary portion having various functions can be provided while the number of the slits is suppressed, an area used to couple the first and second outer conductors can be ensured in the overlapping portion. Further, the shape of the auxiliary portion is easily simplified.

### DETAILS OF EMBODIMENT OF PRESENT DISCLOSURE

### Embodiment

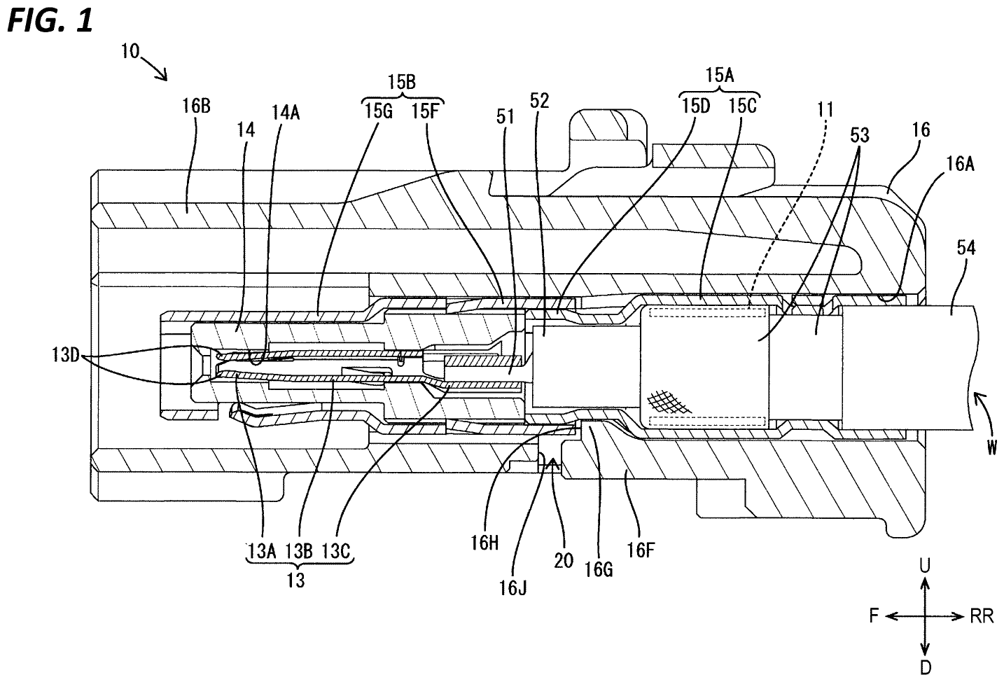

One embodiment of a technique disclosed in this specification is described below with reference to FIGS. 1 to 8. In the following description, right and left sides in FIG. 1 are defined as front and rear sides concerning a front-rear direction. Upper and lower sides in FIG. 1 are directly defined as upper and lower sides concerning a vertical direction.

### [Configuration of Connector]

As shown in FIG. 1, a connector 10 is provided with a sleeve 11, an inner conductor 13, a dielectric 14, a first outer conductor 15A, a second outer conductor 15B, an overlapping portion 20 and a housing 16. The connector 10 is mounted on an end part of a shielded wire W. The sleeve 11, the first outer conductor 15A, the inner conductor 13 and the second outer conductor 15B are made of metal. The dielectric 14 and the housing 16 are made of synthetic resin.

The shielded wire W, which is a cable, is a so-called axial wire. The shielded wire W includes an electrically conductive core wire 51 formed by twisting a plurality of strands, an insulating coating 52 surrounding the outer periphery of the core wire 51, an electrically conductive braided wire 53 surrounding the outer periphery of the coating 52 and formed by braiding strands into a net, and an insulating sheath 54 surrounding the outer periphery of the braided wire 53. The core wire 51 has a function of transmitting a high-frequency signal. The braided wire 53 has a function of shielding electromagnetic waves. The shielded wire W is formed such that the core wire 51 and the braided wire 53 are successively exposed from a tip side by stripping the sheath 54 and the coating 52.

The sleeve 11 has an annular shape. The sleeve 11 is arranged to surround the outer periphery of the braided wire 53 and has an outer surface covered by a tip part of the folded braided wire 53. The sleeve 11 has a function of receiving a crimping load.

The inner conductor 13 is formed, such as by bending a metal plate. The inner conductor 13 is configured by successively connecting a mating connecting portion 13A, a tubular portion 13B and a center conductor crimping portion 13C from a front side to a rear side.

The tubular portion 13B has a hollow cylindrical shape elongated in the front-rear direction. The mating connecting portion 13A is constituted by a pair of resilient pieces 13D projecting forward from the tubular portion 13B. The respective resilient pieces 13D are arranged to face each other across an axis of the tubular portion 13B. If tab (not shown) of a mating inner conductor is inserted between the respective resilient pieces 13D, the respective resilient pieces 13D are expanded, guide the tab and sandwich the tab. The center conductor crimping portion 13C is in the form of an open barrel and connected to the rear end of the tubular portion 13B. The exposed core wire 51 of the shielded wire W is inserted into the center conductor crimping portion 13C. The center conductor crimping portion 13C is crimped to the core wire 51, whereby the inner conductor 13 and the core wire 51 are coupled.

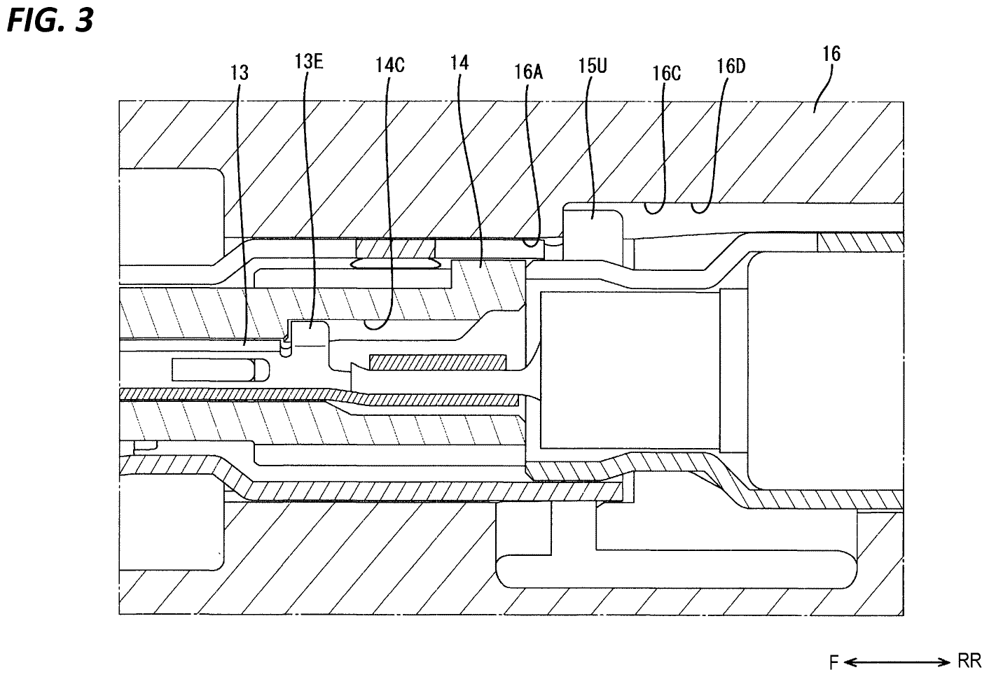

The dielectric 14 has a tubular shape and is formed with an inner conductor insertion hole 14A penetrating in the front-rear direction and having a circular cross-section. The inner conductor 13 is inserted into the inner conductor insertion hole 14A of the dielectric 14 from behind. As shown in FIG. 3, the inner conductor 13 is provided with a contact stop portion 13E, and the contact stop portion 13E comes into contact with the front end of a contact stop receiving portion 14C formed in the inner insertion hole 14E, whereby the inner conductor 13 is prevented from moving any further forward with respect to the dielectric 14.

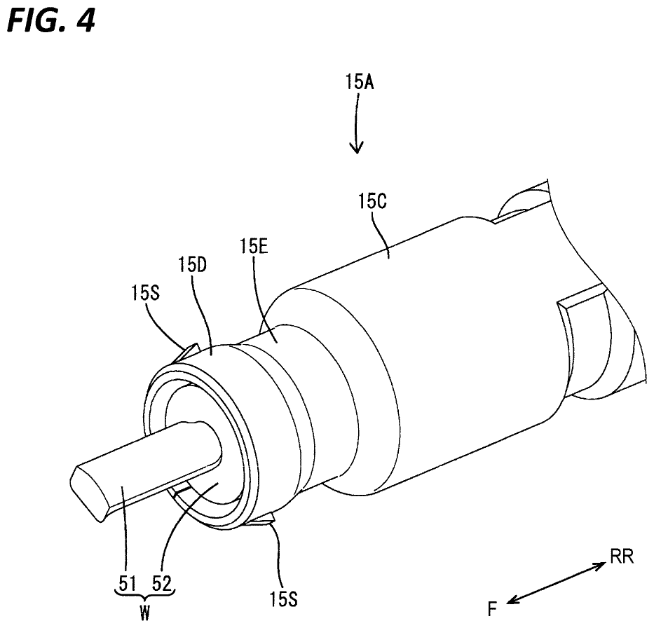

The first outer conductor 15A is formed into a hollow cylindrical shape, such as by bending a metal plate. As shown in FIG. 4, the first outer conductor 15A includes a first tube portion 15C and a second tube portion 15D. The first and second tube portions 15C, 15D are coaxially arranged. An outer diameter of the first tube portion 15C is larger than that of the second tube portion 15D. A reduced diameter portion 15E is formed between the first and second tube portions 15C, 15D. An outer diameter of the reduced diameter portion 15E is smaller than those of the first and second tube portions 15C, 15D. The first tube portion 15C surrounds the sleeve 11 covered by the tip part of the folded braided wire 53 (see FIG. 1). The second tube portion 15D is arranged forward of the first tube portion 15C on an end part of the coating 52 of the shielded wire W. The first outer conductor 15A is coupled to the shielded wire W by being crimped to a front end part of the shielded wire W (see FIG. 1). The rear end of the dielectric 14 is arranged adjacent to the tip of the second tube portion 15D (see FIG. 1).

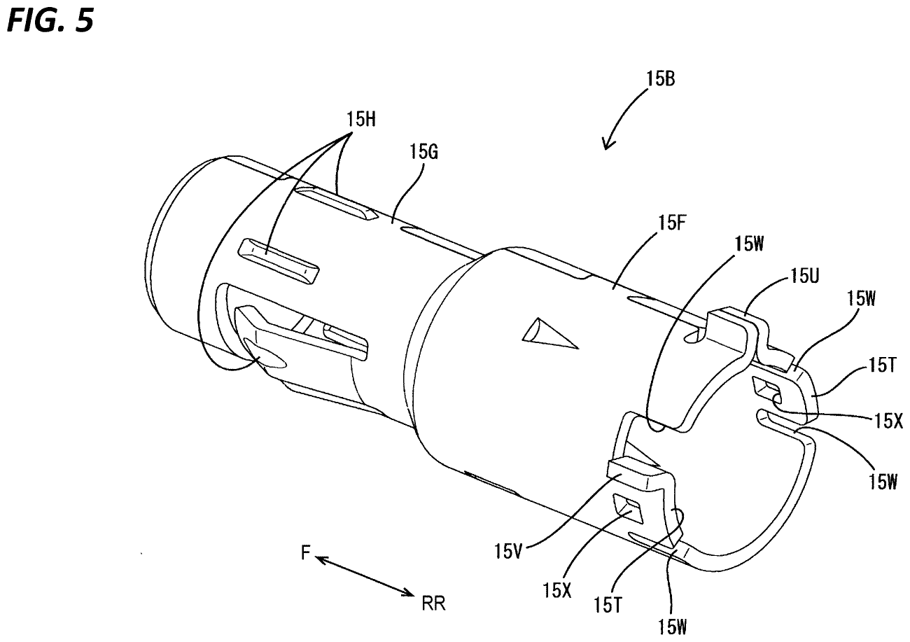

The second tube portion 15D of the first outer conductor 15A is provided with a pair of first projecting portions 15S projecting radially outward. These first projecting portions 15S are arranged opposite to each other across an axis of the second tube portion 15D. These first projecting portions 15S are formed by cutting and raising parts of the second tube portion 15D. These first projecting portions 15S are inclined to increase a spacing therebetween toward a rear side. The rear ends of these first projecting portions 15S are upright in a direction orthogonal to an axial direction. The second outer conductor 15B is formed into a hollow cylindrical shape, such as by bending a metal plate. As shown in FIG. 5, the second outer conductor 15B includes a third tube portion 15F and a fourth tube portion 15G. The third and fourth tube portions 15F, 15G are coaxially arranged. An outer diameter of the third tube portion 15F is larger than that of the fourth tube portion 15G. The second tube portion 15D of the first outer conductor 15A is fit into the third tube portion 15F (see FIG. 1). The fourth tube portion 15G is located forward of the third tube portion 15F.

A pair of locking portions 15T, a plurality of slits 15W, a second projecting portion 15U and a third projecting portion 15V are provided in a rear end part of the third tube portion 15F of the second outer conductor 15B. The pair of locking portions 15T are arranged opposite to each other across an axis of the third tube portion 15F. Each of these locking portions 15T is formed by a pair of the slits 15W. In other words, the slit W is formed on each of both sides in a circumferential direction of the locking portion 15T in the third tube portion 15F.

Each slit 15W is formed to extend forward from the rear end of the third tube portion 15F. The locking portion 15T is a part sandwiched between the pair of slits 15W. Each locking portion 15T is formed with a through hole 15X penetrating in a plate thickness direction. Each locking portion 15T is resiliently deformable radially outward with the front ends (back ends) of the slits 15 as support points.

The second projecting portion 15U is provided in a part where ends of the metal plate are butted against each other to form the second outer conductor 15B. Specifically, the second projecting portion 15U is formed by cutting and raising parts of the respective ends of the metal plate butted against each other radially outward to face in one and the other directions along the circumferential direction so that the cut parts are adjacent in the circumferential direction.

The third projecting portion 15V is provided to be continuous with one locking portion 15T. The third projecting portion 15V is formed by cutting and raising a part of the third tube portion 15F radially outward to face in the circumferential direction. The third projecting portion 15V rises radially outward from one side in the circumferential direction in the one locking portion 15T. The third projecting portion 15V is facing the slit 15W. That is, the outer shape of the one locking portion 15T and that of the third projecting portion 15V are facing one common slit 15W.

The second and third projecting portions 15U, 15V are arranged side by side in the circumferential direction in the third tube portion 15F of the second outer conductor 15B. The second and third projecting portions 15U, 15V are arranged on one of two sides of the third tube portion 15F divided in the circumferential direction by the pair of locking portions 15T. A thickness of the second projecting portion 15U in the circumferential direction of the third tube portion 15F is larger than that of the third projecting portion 15V. The fourth tube portion 15G is provided with a plurality of contact point portions 15H configured to contact the inner surface of a mating outer conductor (not shown) formed into a tubular shape.

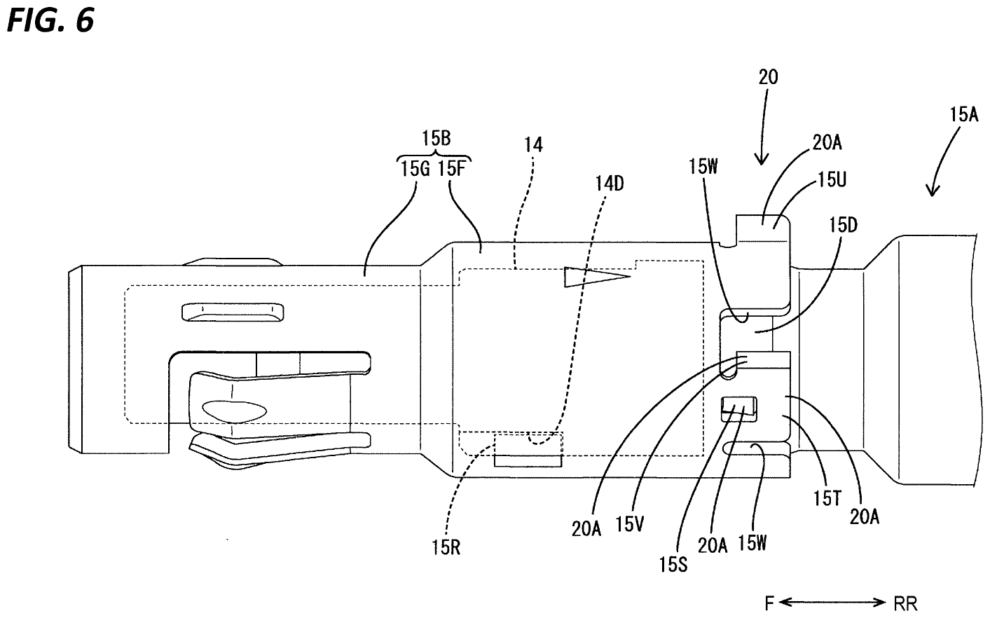

The dielectric 14 is inserted into the second outer conductor 15B from behind (see FIG. 1). As shown in FIG. 6, the third tube portion 15F of the second outer conductor 15B is provided with a projecting portion 15R projecting inward. This projecting portion 15R comes into contact with the rear end of a recess 14D formed on the outer surface of the dielectric 14 from front, whereby the dielectric 14 is prevented from moving any further forward with respect to the second outer conductor 15B. The second outer conductor 15B is arranged to be coaxially connected to a front end part of the first outer conductor 15A and extend forward of the shielded wire W (see FIG. 1).

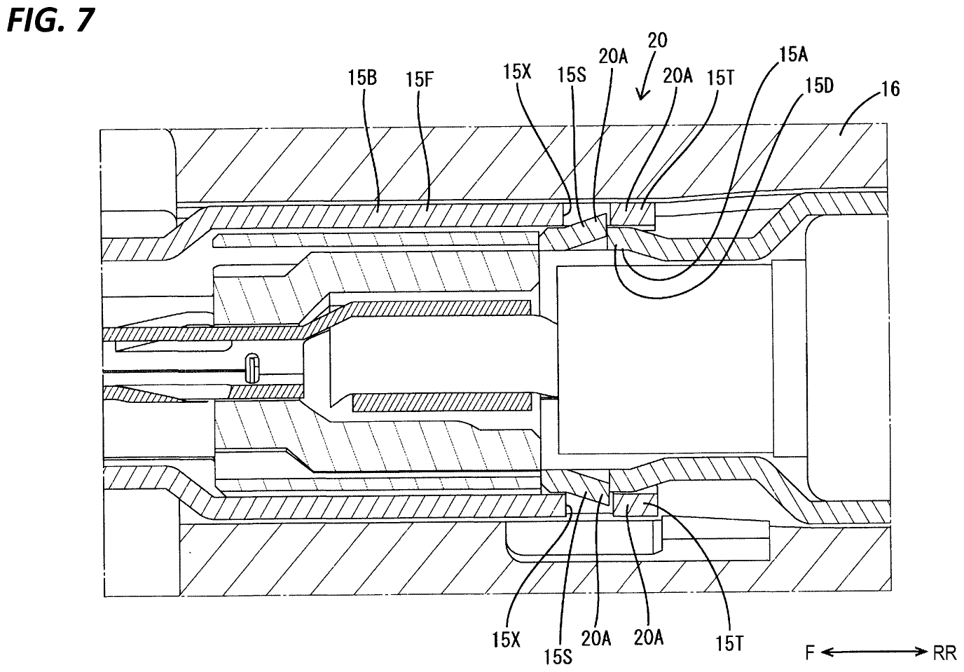

As shown in FIGS. 6 and 7, the overlapping portion 20 is a part constituted by the front end part of the first outer conductor 15A and a rear end part of the second outer conductor 15 overlapped on the front end part of the first outer conductor 15A by externally fitting the second outer conductor 15 on the front end part of the first outer conductor 15A. The overlapping portion 20 includes an auxiliary portion 20A for assisting the assembly of the connector 10. The auxiliary portion 20A includes the pair of first projecting portions 15S, the pair of locking portions 15T, the second projecting portion 15U and the third projecting portion 15V described above. The slit 15W is formed on each of the both sides in the circumferential direction of the locking portion 15T in the overlapping portion 20 (see FIG. 6).

The overlapping portion 20 is formed by fitting the second tube portion 15D of the first outer conductor 15A into the third tube portion 15F of the second outer conductor 15B. At this time, the pair of locking portions 15T of the third tube portion 15F ride on the first projecting portions 15S of the second tube portion 15D and are resiliently deformed radially outward. The respective resiliently deformed locking portions 15T return to an original posture when the rear ends of the respective first projecting portions 15S enter the through holes 15X of the respective locking portions 15T (see FIG. 7). In this way, the first projecting portions 15S are locked to the locking portions 15T. By locking the first projecting portions 15S to the locking portions 15T, the second outer conductor 15B is coaxially connected to the front end part of the first outer conductor 15A and extends forward of the shielded wire W, and a contact state of the outer surface of the second tube portion 15D and the inner surface of the third tube portion 15F is maintained.

Then, the first and second outer conductors 15A, 15B are coupled by applying spot-welding at a plurality of different positions in regions of the overlapping portion 20 where the locking portions 15T, the slits 15W, the second projecting portion 15U and the third projecting portion 15V are not formed. Here, the regions of the overlapping portion 20 where the locking portions 15T, the slits 15W, the second projecting portion 15U and the third projecting portion 15V are not formed are regions of the overlapping portion 20 where the third and second tube portions 15F, 15D are both kept to have a hollow cylindrical shape. In this way, the first projecting portions 15S and the locking portions 15T function as the auxiliary portion 20A for assisting the assembly of the first and second outer conductors 15A, 15B.

As shown in FIG. 1, the housing 16 is in the form of a block formed with a cavity 16A penetrating in the front-rear direction and extending long in the front-rear direction. The housing 16 is connectable to an unillustrated mating housing. A lock arm 16B is provided resiliently deformably on the upper surface of the housing 16. The lock arm 16B has a function of holding the housing 16 and the mating housing in a connected state by being resiliently locked to a lock portion of the unillustrated mating housing.

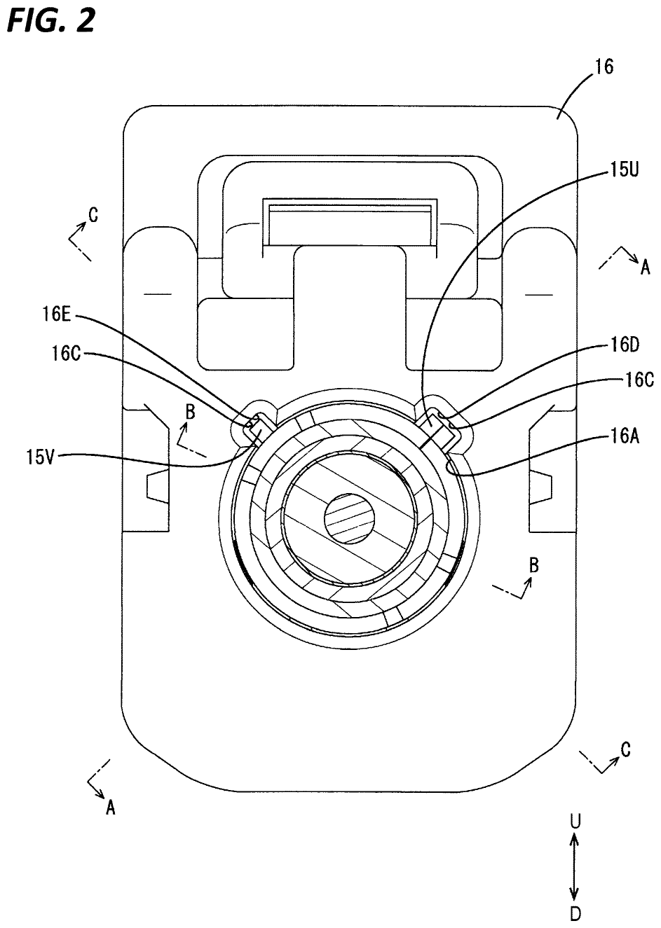

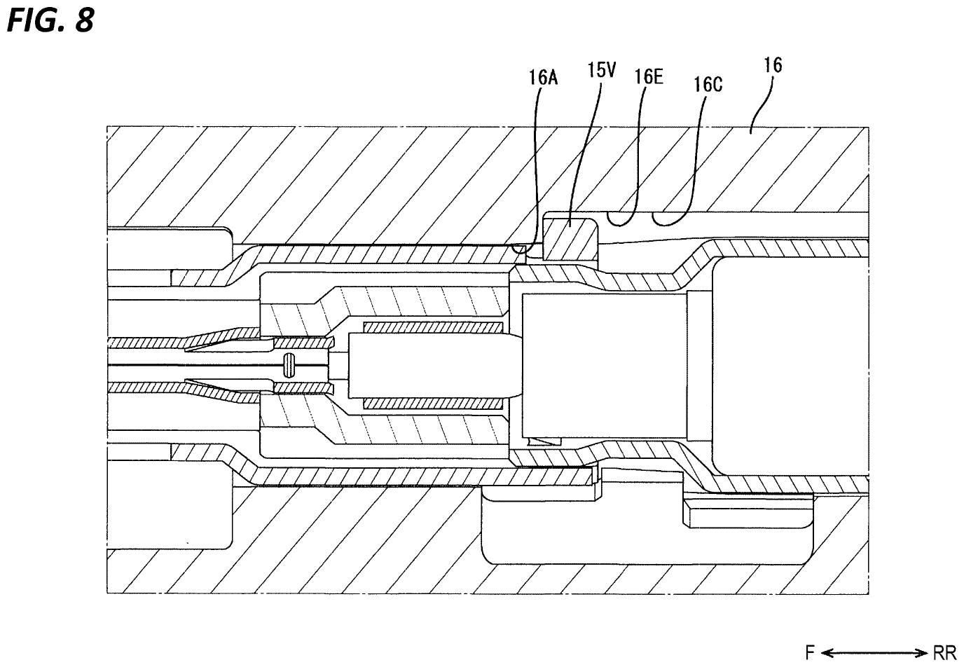

As shown in FIG. 2, the housing 16 includes accommodating portions 16C. The accommodating portions 16C include a first groove 16D extending in the front-rear direction while communicating with the cavity 16A and a second groove 16E extending in the front-rear direction while communicating with the cavity 16A (see FIGS. 3 and 8). The first and second grooves 16D, 16E are formed to be recessed in directions separating from an axis of the cavity 16A. The first and second grooves 16D, 16E are arranged side by side in the circumferential direction on an upper side of the inner surface of the cavity 16A. A width of the first groove 16D in the circumferential direction of the inner surface of the cavity 16A is larger than that of the second groove 16E.

The front ends of the first and second grooves 16D, 16E are closed in a center in the front-rear direction of the housing 16 (see FIGS. 3 and 8). The rear ends of the first and second grooves 16D, 16E are open in the rear surface of the housing 16 (see FIG. 2). The front ends of the first and second grooves 16D, 16E are aligned in position in the front-rear direction.

The shielded wire W mounted with the sleeve 11, the inner conductor 13, the dielectric 14, the first outer conductor 15A and the second outer conductor 15B is inserted into the cavity 16A of the housing 16 from behind. At this time, the second outer conductor 15B is inserted into the cavity 16A of the housing 16 from behind the housing 16. Then, the second projecting portion 15U is inserted into the first groove 16D from behind and the third projecting portion 15V is inserted into the second groove 16E from behind. That is, the accommodating portions 16C are formed by being recessed to correspond to the third and second projecting portions 15V, 15U, and the third and second projecting portions 15V, 15U are respectively inserted thereinto.

As shown in FIG. 1, the lower wall of the cavity 16A of the housing 16 is provided with a locking lance 16F cantilevered forward. The locking lance 16F includes a locking projection 16G projecting into the cavity 16A on a tip part (front end part). The front end of the locking projection 16G is formed into a locking surface 16H upright in the vertical direction.

A retainer insertion hole 16J open in a direction intersecting (orthogonal to) the cavity 16A is formed to penetrate through the lower wall of the housing 16 around the locking lance 16F. An unillustrated retainer is inserted into the retainer insertion hole 16J from below.

[Concerning Insertion of Shielded Wire into Housing]

An operation of inserting the shielded wire W mounted with the sleeve 11, the inner conductor 13, the dielectric 14, the first outer conductor 15A and the second outer conductor 15B into the housing 16 is described. First, the tip of the fourth tube portion 15G of the second outer conductor 15B is arranged behind the housing 16 to be butted against the housing 16. At this time, the cavity 16A of the housing 16 and the second outer conductor 15B are coaxially arranged, the second projecting portion 15U is arranged behind the first groove 15D and the third projecting portion 15V is arranged behind the second groove 16E.

Then, the fourth tube portion 15G of the second outer conductor 15B is inserted into the cavity 16A of the housing 16. As the second outer conductor 15B is further inserted into the cavity 16A, the second projecting portion 15U is inserted into the first groove 16D from behind and the third projecting portion 15V is inserted into the second groove 16E from behind (see FIG. 2). As the second outer conductor 15B is further inserted into the cavity 16A, the second projecting portion 15U moves forward in the first groove 16D and the third projecting portion 15V moves forward in the second groove 16E.

Then, the front end of the third tube portion 15F contacts the locking projection 16G of the locking lance 16F. The locking lance 16F is pushed downward by the third tube portion 15F and resiliently deformed. When the rear end of the third tube portion 15F reaches a position forward of the locking surface 16H of the locking projection 16G, the resiliently deformed locking lance 16F returns to an original shape (see FIG. 1).

As the second outer conductor 15B is further inserted into the cavity 16A, the second projecting portion 15U comes into contact with the front end of the first groove 16D and the third projecting portion 15V comes into contact with the front end of the second groove 16E (see FIGS. 3 and 8). In this way, the second and third projecting portions 15U, 15V are prevented from moving any further forward by the first and second grooves 16D, 16E to restrict the insertion of the second outer conductor 15B beyond a proper insertion position into the housing 16. That is, the second and third projecting portions 15U, 15V function as the auxiliary portion 20A for restricting the insertion of the second outer conductor 15B beyond the proper insertion position into the housing 16 and assisting the assembly of the connector 10. Then, the second outer conductor 15B is retained by the locking lance 16F.

Next, functions and effects of this embodiment are described. The connector 10 of the present disclosure is provided with the first outer conductor 15A, the second outer conductor 15B and the overlapping portion 20. The first outer conductor 15A has a hollow cylindrical shape and is crimped to the front end part of the shielded wire W. The second outer conductor 15B has a hollow cylindrical shape, is coaxially and externally fit to the front end part of the first outer conductor 15A and extends forward of the first outer conductor 15A. The overlapping portion 20 is constituted by the front end part of the first outer conductor 15A and the rear end part of the second outer conductor 15B to be overlapped on the front end part of the first outer conductor 15A. The overlapping portion 20 includes the auxiliary portion 20A for assisting the assembly of the connector 10. According to this configuration, the first and second outer conductors 15A, 15B can be easily assembled by providing the overlapping portion 20 with the auxiliary portion 20A.

The auxiliary portion 20A of the connector 10 of the present disclosure includes the first projecting portions 15S provided in the first outer conductor 15A and projecting radially outward and the locking portions 15T provided in the second outer conductor 15B and to be locked by the first projecting portions 15S. According to this configuration, the relative positions of the first and second outer conductors 15A, 15B are easily stabilized and the first and second outer conductors 15A, 15B can be easily assembled by locking the first projecting portions 15S to the locking portions 15T.

In the connector 10 of the present disclosure, the slit 15W extending forward from the rear end of the second outer conductor 15B is formed on each of the both sides in the circumferential direction of the locking portion 15T. According to this configuration, when the second outer conductor 15B is externally fit to the end part of the first outer conductor 15A, the locking portions 15T can be easily locked to the first projecting portions 15S by being resiliently deformed outward.

The connector 10 of the present disclosure is further provided with the housing 16, into which the second outer conductor 15B is inserted, and the second outer conductor 15B is inserted into the housing 16 from behind the housing 16. The auxiliary portion 20A includes the second projecting portion 15U provided in the second outer conductor 15B, projecting radially outward and configured to restrict the insertion of the second outer conductor 15B beyond the proper insertion position into the housing 16. According to this configuration, since the second outer conductor 15B can be provided with the second projecting portion 15U while a shielding function in the overlapping portion 20 is ensured by the first outer conductor 15A, the shape of the second projecting portion 15U can be determined without considering the shielding function. Thus, the second projecting portion 15U is more flexibly shaped.

The auxiliary portion 20A of the connector 10 of the present disclosure includes the third projecting portion 15V provided in the second outer conductor 15B and projecting radially outward, and the third and second projecting portions 15V, 15U are arranged side by side in the circumferential direction of the second outer conductor 15B. The housing 16 includes the accommodating portions 16C formed by being recessed to correspond to the third and second projecting portions 15V, 15U and configured to accommodate the respective third and second projecting portions 15V, 15U. According to this configuration, it is possible to prevent the insertion of a component provided with a projecting portion other than the second and third projecting portions 15U, 15V (i.e. a component provided with a projecting portion not corresponding to the accommodating portions 16C) into the housing 16.

The second and third projecting portions 15U, 15V of the connector 10 of the present disclosure are formed by cutting and raising the second outer conductor 15B radially outward, and the third projecting portion 15V is facing the slit 15W. According to this configuration, since the auxiliary portion 20A having various functions can be provided while the number of the slits 15W is suppressed, an area used to couple the first and second outer conductors 15A, 15B can be ensured in the overlapping portion 20. Further, the shape of the auxiliary portion 20A is easily simplified.

### OTHER EMBODIMENTS

The embodiment disclosed this time should be considered illustrative in all aspects, rather than restrictive. The scope of the present invention is not limited to the embodiment disclosed this time, but is represented by claims and intended to include all changes in the scope of claims and in the meaning and scope of equivalents.

Unlike the above embodiment, the second projecting portion may be provided to be continuous with one locking portion and the third projecting portion may be provided using the part formed by butting the ends of the metal plate to form the second outer conductor.

The number of the locking portions and that of the first projecting portions are not limited to those of the above embodiment and may be one, three or more.

Unlike the above embodiment, the third projecting portion may be provided to be continuous with one locking portion and the second projecting portion may be provided to be continuous with the other locking portion. That is, the second projecting portion may be configured similarly to the third projecting portion and the second and third projecting portions may be configured to face the slits.

Unlike the above embodiment, a twisted pair wire may be used instead of the shielded wire.

### LIST OF REFERENCE NUMERALS

10 . . . connector
11 . . . sleeve
13 . . . inner conductor
13A . . . mating connecting portion
13B . . . tubular portion
13C . . . center conductor crimping portion
13D . . . resilient piece
13E . . . contact stop portion
14 . . . dielectric
14A . . . inner conductor insertion hole
14C . . . contact stop receiving portion
14D . . . projection
15A . . . first outer conductor
15B . . . second outer conductor
15C . . . first tube portion
15D . . . second tube portion
15E . . . reduced diameter portion
15F . . . third tube portion
15G . . . fourth tube portion
15H . . . fixed contact point portion
15R . . . projecting portion
15S . . . first projecting portion
15T . . . locking portion
15U . . . second projecting portion
15V . . . third projecting portion
15W . . . slit
15X . . . through hole
16 . . . housing
16A . . . cavity
16B . . . lock arm
16C . . . accommodating portion
16D . . . first groove
16E . . . second groove
16F . . . locking lance
16G . . . locking projection
16H . . . locking surface
16J . . . retainer insertion hole
20 . . . overlapping portion
20A . . . auxiliary portion
51 . . . core wire
52 . . . coating
53 . . . braided wire
54 . . . sheath
W . . . shielded wire (cable)

1. A connector, comprising:
a first outer conductor having a hollow cylindrical shape, the first outer conductor being crimped to a front end part of a cable;
a second outer conductor having a hollow cylindrical shape, the second outer conductor being coaxially and externally fit to a front end part of the first outer conductor and extending forward of the first outer conductor; and
an overlapping portion constituted by the front end part of the first outer conductor and a rear end part of the second outer conductor overlapped on the front end part of the first outer conductor,
the overlapping portion including an auxiliary portion for assisting assembly of the connector.

2. The connector of claim 1, wherein the auxiliary portion includes:
a first projecting portion provided in the first outer conductor and projecting radially outward; and
a locking portion provided in the second outer conductor, the first projecting portion being locked to the locking portion.

3. The connector of claim 2, wherein a slit extending forward from a rear end of the second outer conductor is formed on each of both sides in a circumferential direction of the locking portion.

4. The connector of claim 3, further comprising a housing, the second outer conductor being inserted into the housing, wherein:
the second outer conductor is inserted into the housing from behind the housing, and
the auxiliary portion includes a second projecting portion provided in the second outer conductor, projecting radially outward and configured to restrict insertion of the second outer conductor beyond a proper insertion position into the housing.

5. The connector of claim 4, wherein:
the auxiliary portion includes a third projecting portion provided in the second outer conductor and projecting radially outward,
the third projecting portion and the second projecting portion are arranged side by side in a circumferential direction of the second outer conductor, and
the housing includes accommodating portions formed by being recessed to correspond to the third projecting portion and the second projecting portion, the third projecting portion and the second projecting portion being respectively accommodated into the accommodating portions.

6. The connector of claim 5, wherein:
the second projecting portion and the third projecting portion are formed by cutting and raising the second outer conductor radially outward, and
at least one of the second projecting portion and the third projecting portion is facing the slit.
